(19) United States
(12) Patent Application Publication
(10) Pub. No.: US 2025/0219523 A1
(43) Pub. Date: Jul. 3, 2025

(54) POWER CONVERTER AND METHOD OF OPERATING THE SAME

(71) Applicant: ASIAN POWER DEVICES INC., Taoyuan City (TW)

(72) Inventor: Tsung-Liang HUNG, Taoyuan City (TW)

(21) Appl. No.: 18/605,167

(22) Filed: Mar. 14, 2024

(30) Foreign Application Priority Data
Jan. 2, 2024 (TW) 113100059

(51) Int. Cl. H02M 1/00; H02M 1/42; H02M 3/155

(52) U.S. Cl. CPC H02M 1/0048; H02M 1/42; H02M 3/155

(57) ABSTRACT

A power converter receives an input voltage. The power converter includes a boost power factor correction (PFC) circuit, a DC-to-DC conversion circuit, a bypass switch, and a comparison circuit. The comparison circuit receives the input voltage and a voltage threshold, and compares the input voltage with the voltage threshold to generate a first control signal and a second control signal. When the input voltage is greater than or equal to the voltage threshold, the first control signal turns on the bypass switch and the second control signal disables the boost PFC circuit so that the input voltage is provided to the DC-to-DC conversion circuit and is converted into an output voltage by the DC-to-DC conversion circuit.

### BACKGROUND

### Technical Field

The present disclosure relates to a power converter and a method of operating the same, and more particularly to a power converter with both hold-up time and conversion efficiency and a method of operating the same.

### Description of Related Art

The statements in this section merely provide background information related to the present disclosure and do not necessarily constitute prior art.

Please refer to FIG. 1, which shows a block circuit diagram of a related-art power converter. The power converter is used in a power application structure that generally requires increased hold-up time specifications. A boost converter 100 is first used as a front-stage boost converter to increase the input voltage Vin to a conversion voltage Vbus of a higher output voltage. The conversion voltage Vbus is then converted to the voltage required by the system through a DC-to-DC converter 200. In particular, the output of the front-stage boost converter 100 has sufficient capacitance to store more electric energy. Once the input voltage is in power outage or power failure, sufficient charge can be provided for the subsequent DC-to-DC converter 200 to operate. However, under such a circuit structure, regardless of the input voltage Vin, the front-stage boost converter 100 needs to operate under the control of a switch controller 101 so it is difficult to effectively reduce the conduction loss and increase the overall power efficiency.

Therefore, how to design a power converter and a method of operating the same to solve problems and technical bottlenecks in the existing technology has become a critical topic in this field.

### SUMMARY

An objective of the present disclosure is to provide a power converter. The power converter receives an input voltage. The power converter includes a boost power factor correction circuit, a DC-to-DC conversion circuit, a bypass switch, and a comparison circuit. The DC-to-DC conversion circuit is connected to the boost power factor correction circuit. The bypass switch is connected between the boost power factor correction circuit and the DC-to-DC conversion circuit. The comparison circuit receives the input voltage and a voltage threshold, and compares the input voltage with the voltage threshold to generate a first control signal and a second control signal. When the input voltage is greater than or equal to the voltage threshold, the first control signal turns on the bypass switch and the second control signal disables the boost power factor correction circuit so that the input voltage is provided to the DC-to-DC conversion circuit and the DC-to-DC conversion circuit converts the input voltage into an output voltage.

In one embodiment, when the input voltage is less than the voltage threshold, the first control signal turns off the bypass switch and the second control signal enables the boost power factor correction circuit so that the boost power factor correction circuit performs a power factor correction to the input voltage to generate a conversion voltage, and the conversion voltage is provided to the DC-to-DC conversion circuit and the DC-to-DC conversion circuit converts the conversion voltage into the output voltage.

In one embodiment, the boost power factor correction circuit includes an inductor, a diode, and a switch. The inductor includes a first terminal and a second terminal; the first terminal of the inductor receives the input voltage. The diode includes an anode and a cathode; the anode is connected to the second terminal of the inductor. The switch includes a first terminal, a second terminal, and a control terminal; the first terminal of the switch is connected to the anode of the diode, and the second terminal of the switch is grounded.

In one embodiment, the second control signal controls the switch to disable or enable the boost power factor correction circuit.

In one embodiment, the power converter further includes a switch controller. The switch controller is connected to the control terminal of the switch, and generates a switch control signal to control the turning on and turning off of the switch.

In one embodiment, the second control signal controls the switch controller to disable or enable the boost power factor correction circuit.

In one embodiment, the bypass switch is connected between the first terminal of the inductor and the cathode of the diode.

In one embodiment, the bypass switch includes a first terminal, a second terminal, and a control terminal; the first terminal of the bypass switch is connected to the first terminal of the inductor, and the second terminal of the bypass switch is connected to the cathode of the diode.

In one embodiment, the first control signal controls the turning on and turning off of the bypass switch.

In one embodiment, the power converter further includes a capacitor. The capacitor includes a first terminal and a second terminal; the first terminal of the capacitor receives the input voltage or the conversion voltage.

Another objective of the present disclosure is to provide a method of operating a power converter. The power converter receives an input voltage, and includes a boost power factor correction circuit, a DC-to-DC conversion circuit, and a bypass switch. The method includes steps of: receiving the input voltage and a voltage threshold; comparing the input voltage and the voltage threshold to generate a first control signal and a second control signal; turning on the bypass switch by the first control signal and disabling the boost power factor correction circuit by the second control signal when the input voltage is greater than or equal to the voltage threshold so that the input voltage is provided to the DC-to-DC conversion circuit and the DC-to-DC conversion circuit converts the input voltage into an output voltage.

In one embodiment, the method further includes a step of: turning off the bypass switch by the first control signal and enabling the boost power factor correction circuit by the second control signal when the input voltage is less than the voltage threshold so that the boost power factor correction circuit performs a power factor correction to the input voltage to generate a conversion voltage, and the conversion voltage is provided to the DC-to-DC conversion circuit and the DC-to-DC conversion circuit converts the conversion voltage into the output voltage.

In one embodiment, the boost power factor correction circuit includes an inductor, a diode, and a switch. The inductor includes a first terminal and a second terminal; the first terminal of the inductor receives the input voltage. The diode includes an anode and a cathode; the anode is connected to the second terminal of the inductor. The switch includes a first terminal, a second terminal, and a control terminal; the first terminal of the switch is connected to the anode of the diode, and the second terminal of the switch is grounded.

In one embodiment, the second control signal controls the switch to disable or enable the boost power factor correction circuit.

In one embodiment, the power converter further includes a switch controller. The switch controller is connected to the control terminal of the switch, and generates a switch control signal to control the turning on and turning off of the switch.

In one embodiment, the second control signal controls the switch controller to disable or enable the boost power factor correction circuit.

In one embodiment, the bypass switch is connected between the first terminal of the inductor and the cathode of the diode.

In one embodiment, the bypass switch includes a first terminal, a second terminal, and a control terminal; the first terminal of the bypass switch is connected to the first terminal of the inductor, and the second terminal of the bypass switch is connected to the cathode of the diode.

In one embodiment, the first control signal controls the turning on and turning off of the bypass switch.

In one embodiment, the power converter further includes a capacitor. The capacitor includes a first terminal and a second terminal; the first terminal of the capacitor receives the input voltage or the conversion voltage.

Accordingly, the power converter and the method of operating the same proposed by the present disclosure have the following characteristics and advantages: 1. by adding the bypass switch and detecting the magnitude of the input voltage, when the input voltage is greater than the setting value (i.e., the voltage threshold), the operation of the boost power factor correction circuit is stopped so as to effectively decrease the input voltage passing through the inductor and diode Db of the boost power factor correction circuit, thereby decreasing the conduction loss and increase the overall power efficiency; 2. when the input voltage is less than the voltage threshold, the operation of the boost power factor correction circuit is activated so that once the input voltage fails, the conversion voltage can be increased so that the output voltage converted by the DC-to-DC conversion circuit can still maintain the power supply capability, thereby extending the hold-up time of the power converter.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a related-art power converter.

FIG. 2 is a block circuit diagram of a power converter according to the present disclosure.

FIG. 3 is a waveform diagram related to the power converter in operation according to the present disclosure.

FIG. 4 is a flowchart of a method of operating the power converter according to the present disclosure.

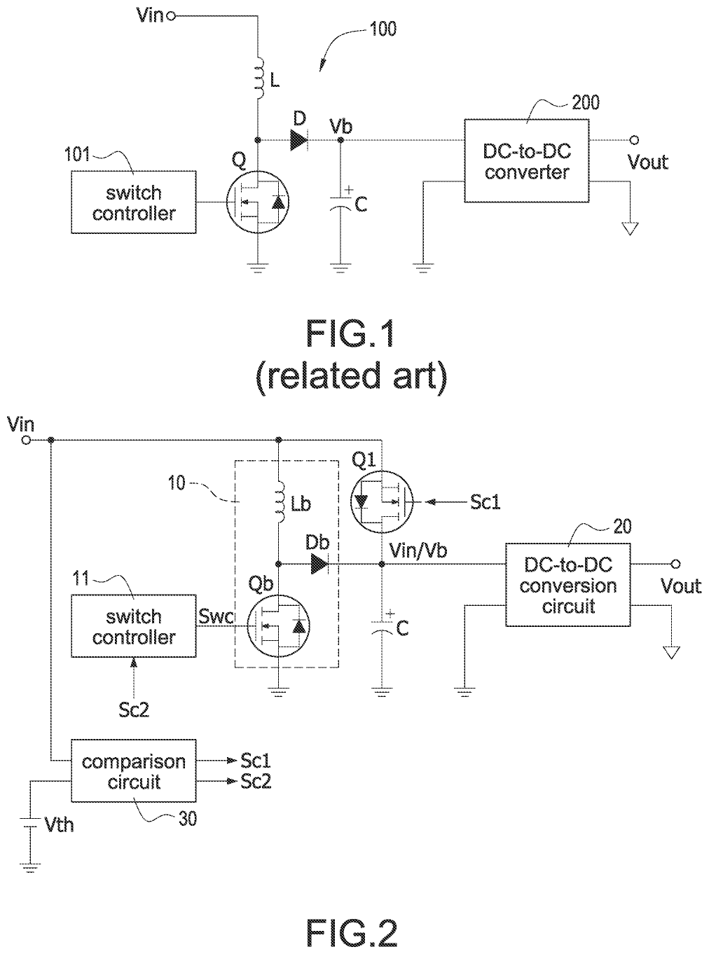

### DETAILED DESCRIPTION

Reference will now be made to the drawing figures to describe the present disclosure in detail. It will be understood that the drawing figures and exemplified embodiments of present disclosure are not limited to the details thereof.

Please refer to FIG. 2, which shows a block circuit diagram of a power converter according to the present disclosure. The power converter receives an input voltage Vin. The power converter includes a boost power factor correction (PFC) circuit 10, a DC-to-DC conversion circuit 20, a bypass switch Q1, and a comparison circuit 30.

The DC-to-DC conversion circuit 20 is connected to the boost power factor correction circuit 10, that is, an input side of the DC-to-DC conversion circuit 20 is connected to an output side of the boost power factor correction circuit 10. The bypass switch Q1 is connected between the boost power factor correction circuit 10 and the DC-to-DC conversion circuit 20. In one embodiment, the bypass switch Q1 may be, for example, but not limited to, a power switch (i.e., a NMOS as shown in FIG. 2), a relay switch, or a switching component or a switching circuit that is generally controlled by an external signal, which can be used as a bypass switch of the present disclosure.

The power converter includes a capacitor C. The capacitor C includes a first terminal and a second terminal. The first terminal of the capacitor C receives the input voltage Vin or the conversion voltage Vb. Afterward, the input voltage Vin or the conversion voltage Vb built on the capacitor C is used as an input voltage of the DC-to-DC conversion circuit 20, and the input voltage of the DC-to-DC conversion circuit 20 is converted by the DC-to-DC conversion circuit 20 into the output voltage Vout.

In this embodiment, the boost power factor correction circuit 10 includes an inductor Lb, a diode Db, and a switch Qb. The inductor Lb includes a first terminal and a second terminal. The first terminal of the inductor Lb receives the input voltage Vin. The diode Db includes an anode and a cathode, and the anode is connected to the second terminal of the inductor Lb. The switch Qb includes a first terminal, a second terminal, and a control terminal. The first terminal of the switch Qb is connected to the anode of the diode Db, and the second terminal of the switch Qb is grounded. In such circuit topology, the bypass switch Q1 is connected between the first terminal of the inductor Lb and the cathode of the switch Db. Specifically, the bypass switch Q1 includes a first terminal, a second terminal, and a control terminal. The first terminal of the bypass switch Q1 is connected to the first terminal of the inductor Lb, and the second terminal of the bypass switch Q1 is connected to the cathode of the diode Db.

The comparison circuit 30 receives the input voltage Vin and a voltage threshold Vth. The comparison circuit 30 compares the input voltage Vin and the voltage threshold Vth to generate a first control signal Sc1 and a second control signal Sc2.

When the input voltage Vin is greater than or equal to the voltage threshold Vth, the first control signal Sc1 turns on the bypass switch Q1, and the second control signal Sc2 disables the boost power factor correction circuit 10 so that the input voltage Vin is provided to the DC-to-DC conversion circuit 20, and the input voltage Vin is converted by the DC-to-DC conversion circuit 20 into the output voltage Vout.

In addition, when the input voltage Vin is less than the voltage threshold Vth, the first control signal Sc1 turns off the bypass switch Q1, and the second control signal Sc2 enables the boost power factor correction circuit 10 so that the boost power factor correction circuit 10 performs a power factor correction to the input voltage Vin to generate a conversion voltage Vb, and the conversion voltage Vb is provided to the DC-to-DC conversion circuit 20 and the DC-to-DC conversion circuit 20 converts the conversion voltage Vb into the output voltage Vout.

In one embodiment, the first control signal Sc1 controls the turning on and turning off of the bypass switch Q1. The second control signal Sc2 controls the turning on and turning off of the switch Qb so as to disable or enable the boost power factor correction circuit 10, that is, the duty cycle of the switch Qb is controlled through the second control signal Sc2 to adjust the magnitude of the conversion voltage Vb.

In one embodiment, the power converter further includes a switch controller 11. The switch controller 11 is connected to the control terminal of the switch Qb, and generates a switch control signal Swc to control the turning on and turning off of the switch Qb so as to disable or enable the boost power factor correction circuit 10, that is, the duty cycle of the switch Qb is controlled through the switch control signal Swc to adjust the magnitude of the conversion voltage Vb. In other words, the previous embodiment is that the second control signal Sc2 directly controls the duty cycle of the switch Qb (without using the switch controller 11), and the next embodiment is that the second control signal Sc2 first controls the switch controller 11 to generate the switch control signal Swc, and then the switch control signal Swc controls the duty cycle of the switch Qb.

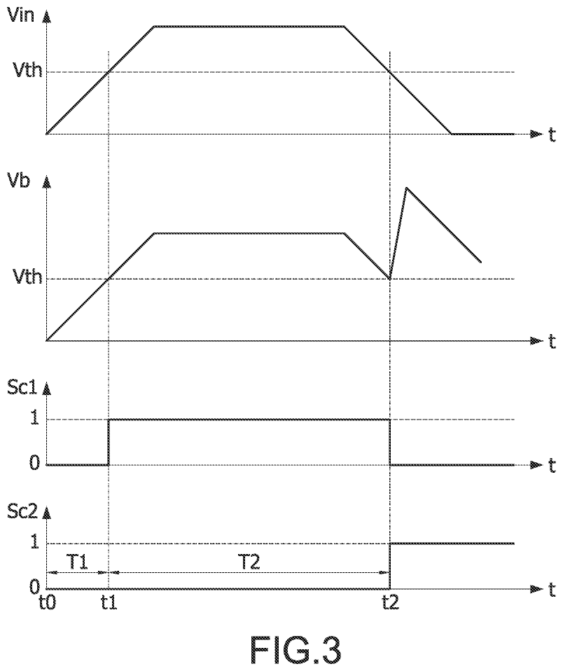

Please refer to FIG. 3, which shows a waveform diagram related to the power converter in operation according to the present disclosure to facilitate the explanation of the technical spirit of the present disclosure. From time to t0 time t1 (that is, the first time interval T1), it is the startup period of the power converter. During this period, since the first control signal Sc1 and the second control signal Sc2 are in low level, the first control signal Sc1 controls the bypass switch Q1 to be turned off, and the second control signal Sc2 controls the switch controller 11 not to turn on the switch Qb. Therefore, the gradually increasing input voltage Vin transmitted to the DC-to-DC conversion circuit 20 through the inductor Lb and diode Db of the boost power factor correction circuit 10, and is then converted into the output voltage Vout through the DC-to-DC conversion circuit 20.

At time t1, since the comparison circuit 30 compares that the input voltage Vin is greater than or equal to the voltage threshold Vth, the first control signal Sc1 changes/transits from a low level to a high level so as to turn on the bypass switch Q1. At this time, the second control signal Sc2 remains at the low level, thereby disabling the boost power factor correction circuit 10. From time t1 to time t2 (that is, the second time interval T1), since the input voltage Vin is greater than or equal to the voltage threshold Vth, the switch Qb is turned off by turning on the bypass switch Q1 so that the input voltage Vin directly passes through the bypass switch Q1 to build the input voltage Vin on the capacitor C, and the input voltage Vin is provided to the DC-to-DC conversion circuit 20 and is converted by the DC-to-DC conversion circuit 20 into the output voltage Vout. Therefore, when the input voltage Vin is higher a setting value, i.e., the voltage threshold Vth, the operation of the boost power factor correction circuit 10 is stopped so as to effectively decrease the input voltage passing through the inductor Lb and diode Db of the boost power factor correction circuit 10, thereby decreasing the conduction loss and increase the overall power efficiency. During the period, the power converter maintains high-efficiency operation.

At time t2, (incidentally, the condition after time t2 may not occur, and it is just for convenience to illustrate that the input voltage decreases and the hold-up time function needs to be activated), since the comparison circuit 30 compares that the input voltage Vin is less than the voltage threshold Vth, the first control signal Sc1 changes/transits from the high level to the low level so as to turn off the bypass switch Q1. Also, the second control signal Sc2 changes/transits from the low level to the high level so as to enable the boost power factor correction circuit 10. Therefore, the gradually decreasing input voltage Vin is boosted/stepped up through the boost power factor correction circuit 10 so that the conversion voltage Vb, which is built on the capacitor C, generated by the boost power factor correction circuit 10 is pulled high (boosted). Accordingly, when the input voltage Vin fails, the conversion voltage Vb can be increased so that the output voltage Vout converted by the DC-to-DC conversion circuit 20 can still maintain the power supply capability, thereby extending the hold-up time of the power converter.

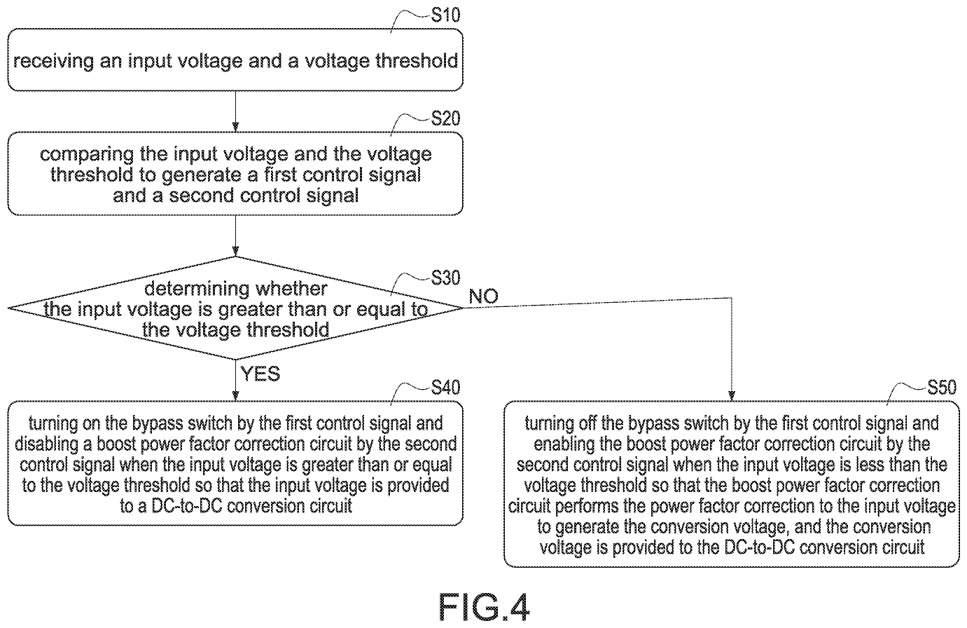

Please refer to FIG. 4, which shows a flowchart of a method of operating the power converter according to the present disclosure. The method includes steps of: receiving the input voltage Vin and the voltage threshold Vth (S10). Afterward, comparing the input voltage Vin and the voltage threshold Vth to generate a first control signal Sc1 and a second control signal Sc2 (S20). Afterward, determining whether the input voltage Vin is greater than or equal to the voltage threshold Vth (S30).

Afterward, turning on the bypass switch Q1 by the first control signal Sc1 and disabling the boost power factor correction circuit 10 by the second control signal Sc2 when the input voltage Vin is greater than or equal to the voltage threshold Vth so that the input voltage Vin is provided to the DC-to-DC conversion circuit 20 and the DC-to-DC conversion circuit 20 converts the input voltage Vin into the output voltage Vout (S40).

On the contrary, turning off the bypass switch Q1 by the first control signal Sc1 and enabling the boost power factor correction circuit 10 by the second control signal Sc2 when the input voltage Vin is less than the voltage threshold Vth so that the boost power factor correction circuit 10 performs the power factor correction to the input voltage Vin to generate the conversion voltage Vb, and the conversion voltage Vb is provided to the DC-to-DC conversion circuit 20 and the DC-to-DC conversion circuit 20 converts the conversion voltage Vb into the output voltage Vout (S50).

The details of the above method steps can be found in the description of the power converter mentioned above, so they will not be repeated here.

In summary, the present disclosure has the following features and advantages:

1. By adding the bypass switch Q1 and detecting the magnitude of the input voltage Vin, when the input voltage Vin is greater than the setting value (i.e., the voltage threshold Vth), the operation of the boost power factor correction circuit 10 is stopped so as to effectively decrease the input voltage passing through the inductor Lb and diode Db of the boost power factor correction circuit 10, thereby decreasing the conduction loss and increase the overall power efficiency.

2. When the input voltage Vin is less than the voltage threshold Vth, the operation of the boost power factor correction circuit 10 is activated so that once the input voltage Vin fails, the conversion voltage Vb can be increased so that the output voltage Vout converted by the DC-to-DC conversion circuit 20 can still maintain the power supply capability, thereby extending the hold-up time of the power converter.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A power converter configured to receive an input voltage, and the power converter comprising:
a boost power factor correction circuit,
a DC-to-DC conversion circuit connected to the boost power factor correction circuit,
a bypass switch connected between the boost power factor correction circuit and the DC-to-DC conversion circuit, and
a comparison circuit configured to receive the input voltage and a voltage threshold, and compare the input voltage with the voltage threshold to generate a first control signal and a second control signal,
wherein when the input voltage is greater than or equal to the voltage threshold, the first control signal turns on the bypass switch and the second control signal disables the boost power factor correction circuit so that the input voltage is provided to the DC-to-DC conversion circuit and the DC-to-DC conversion circuit converts the input voltage into an output voltage.

2. The power converter as claimed in claim 1, wherein when the input voltage is less than the voltage threshold, the first control signal turns off the bypass switch and the second control signal enables the boost power factor correction circuit so that the boost power factor correction circuit performs a power factor correction to the input voltage to generate a conversion voltage, and the conversion voltage is provided to the DC-to-DC conversion circuit and the DC-to-DC conversion circuit converts the conversion voltage into the output voltage.

3. The power converter as claimed in claim 1, wherein the boost power factor correction circuit comprises:
an inductor comprising a first terminal and a second terminal; the first terminal of the inductor configured to receive the input voltage,
a diode comprising an anode and a cathode; the anode connected to the second terminal of the inductor, and
a switch comprising a first terminal, a second terminal, and a control terminal; the first terminal of the switch connected to the anode of the diode, and the second terminal of the switch is grounded.

4. The power converter as claimed in claim 3, wherein the second control signal is configured to control the switch to disable or enable the boost power factor correction circuit.

5. The power converter as claimed in claim 3, further comprising:
a switch controller connected to the control terminal of the switch, and configured to generate a switch control signal to control the turning on and turning off of the switch.

6. The power converter as claimed in claim 5, wherein the second control signal is configured to control the switch controller to disable or enable the boost power factor correction circuit.

7. The power converter as claimed in claim 3, wherein the bypass switch is connected between the first terminal of the inductor and the cathode of the diode.

8. The power converter as claimed in claim 7, wherein the bypass switch comprises a first terminal, a second terminal, and a control terminal; the first terminal of the bypass switch is connected to the first terminal of the inductor, and the second terminal of the bypass switch is connected to the cathode of the diode.

9. The power converter as claimed in claim 8, wherein the first control signal is configured to control the turning on and turning off of the bypass switch.

10. The power converter as claimed in claim 2, further comprising:
a capacitor comprising a first terminal and a second terminal; the first terminal of the capacitor is configured to receive the input voltage or the conversion voltage.

11. A method of operating a power converter, the power converter configured to receive an input voltage, and comprising a boost power factor correction circuit, a DC-to-DC conversion circuit, and a bypass switch, the method comprising steps of:
receiving the input voltage and a voltage threshold,
comparing the input voltage and the voltage threshold to generate a first control signal and a second control signal, and
turning on the bypass switch by the first control signal and disabling the boost power factor correction circuit by the second control signal when the input voltage is greater than or equal to the voltage threshold so that the input voltage is provided to the DC-to-DC conversion circuit and the DC-to-DC conversion circuit converts the input voltage into an output voltage.

12. The method of operating the power converter as claimed in claim 11, further comprising a step of:
turning off the bypass switch by the first control signal and enabling the boost power factor correction circuit by the second control signal when the input voltage is less than the voltage threshold so that the boost power factor correction circuit performs a power factor correction to the input voltage to generate a conversion voltage, and the conversion voltage is provided to the DC-to-DC conversion circuit and the DC-to-DC conversion circuit converts the conversion voltage into the output voltage.

13. The method of operating the power converter as claimed in claim 11, wherein the boost power factor correction circuit comprises:
an inductor comprising a first terminal and a second terminal; the first terminal of the inductor configured to receive the input voltage,
a diode comprising an anode and a cathode; the anode connected to the second terminal of the inductor, and
a switch comprising a first terminal, a second terminal, and a control terminal; the first terminal of the switch connected to the anode of the diode, and the second terminal of the switch is grounded.

14. The method of operating the power converter as claimed in claim 13, wherein the second control signal is configured to control the switch to disable or enable the boost power factor correction circuit.

15. The method of operating the power converter as claimed in claim 13, wherein the power converter further comprises:
a switch controller connected to the control terminal of the switch, and configured to generate a switch control signal to control the turning on and turning off of the switch.

16. The method of operating the power converter as claimed in claim 15, wherein the second control signal is configured to control the switch controller to disable or enable the boost power factor correction circuit.

17. The method of operating the power converter as claimed in claim 13, wherein the bypass switch is connected between the first terminal of the inductor and the cathode of the diode.

18. The method of operating the power converter as claimed in claim 17, wherein the bypass switch comprises a first terminal, a second terminal, and a control terminal; the first terminal of the bypass switch is connected to the first terminal of the inductor, and the second terminal of the bypass switch is connected to the cathode of the diode.

19. The method of operating the power converter as claimed in claim 18, wherein the first control signal is configured to control the turning on and turning off of the bypass switch.

20. The method of operating the power converter as claimed in claim 12, wherein the power converter further comprises:
a capacitor comprising a first terminal and a second terminal; the first terminal of the capacitor is configured to receive the input voltage or the conversion voltage.
